(19) United States
(12) Patent Application Publication
(10) Pub. No.: US 2023/0311660 A1
(43) Pub. Date: Oct. 5, 2023

(54) Decorative Vehicle Glass Device

(71) Applicant: David Torres, Beaumont, CA (US)

(72) Inventor: David Torres, Beaumont, CA (US)

(21) Appl. No.: 18/295,662

(22) Filed: Apr. 4, 2023

Related U.S. Application Data
(60) Provisional application No. 63/327,095, filed on Apr. 4, 2022.

(51) Int. Cl. B60K 35/00; C03C 23/00

(52) U.S. Cl. CPC B60K 35/00; C03C 23/006; B60K 2370/152; B60K 2370/20; B60K 2370/46; B60K 2370/56; B60K 2370/589; B60K 2370/785

(57) ABSTRACT

The present invention relates to a decorative vehicle glass device. The device is comprised of a glass body that can be used as a windshield, window, engine cover, etc. on a vehicle. The glass body is comprised of an internal gas and at least one electrode that produces an alternating current which is transmitted through at least one plasma filament within the glass body. This creates colorful tendrils of light within the glass which resembles the appearance of lightning.

### CROSS-REFERENCE TO RELATED APPLICATION

The present application claims priority to, and the benefit of, U.S. Provisional Application No. 63/327,095, which was filed on Apr. 4, 2022, and is incorporated herein by reference in its entirety.

### FIELD OF THE INVENTION

The present invention relates generally to the field of vehicle glass. More specifically, the present invention relates to a decorative vehicle glass device that produces tendrils of light that resemble lightning within a glass body that can be used as a vehicle windshield, side window, engine cover, etc. Accordingly, the present disclosure makes specific reference thereto. Nonetheless, it is to be appreciated that aspects of the present invention are also equally applicable to other like applications, devices, and methods of manufacture.

### BACKGROUND

Many vehicle enthusiasts look for unique ways to customize their vehicle. However, most vehicle customizations such as vinyl wraps, window tints, body skits, paint, etc. are commonplace. As a result, vehicle enthusiasts may look for a more unique way to customize the appearance of their vehicle than what is currently available in the art.

Therefore, there exists a long-felt need in the art for a vehicle customization device. There also exists a long-felt need in the art for a vehicle customization device that can be used to customize a window of a vehicle. More specifically, there exists a long-felt need in the art for a decorative vehicle glass device that can be used to customize a window of a vehicle. In addition, there exists a long-felt need in the art for a decorative vehicle glass device that can be used to customize a window of a vehicle in a unique and visually appealing manner.

The subject matter disclosed and claimed herein, in one embodiment thereof, comprises a decorative vehicle glass device. The device is comprised of a glass body that can be used as a windshield, window, engine cover, etc. on a vehicle. The glass body is comprised of an internal gas and at least one electrode. The electrode produces an alternating current which is transmitted through at least one plasma filament within the glass body to create colorful tendrils of light within the glass to give the appearance of lightning.

In this manner, the decorative vehicle glass device of the present invention accomplishes all the forgoing objectives and provides a device for customizing the appearance of a vehicle. More specifically, the decorative vehicle glass device can be used to customize a window of a vehicle in a unique and visually appealing manner. This is done via the creation of tendrils of light within the glass body of the device which resembles lighting.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a decorative vehicle glass device comprised of a glass body that can be used in vehicle front windshields, rear windshields, engine bay windows, side windows, etc. The glass body is preferably comprised of a plasma glass or a double-paned glass that allows at least one gas to be positioned within the body between the two panes and/or within the glass. The gas is preferably a hot, ionized gas containing roughly equal quantities of positively charged ions and negatively charged electrons.

The glass body is comprised of at least one electrode that preferably emits a high-frequency, high-voltage alternating electric current. The electric current created by the electrode is transmitted through at least one plasma filament within the glass body. When this occurs, the filaments create colorful tendrils of light within the glass.

In one embodiment, the electrode is in wireless or wired electrical communication with the electrical system of the vehicle. In this embodiment, the voltage created by the electrode increases as the speed of the vehicle increases. This creates larger and more tendrils as the vehicle accelerates.

Accordingly, the decorative vehicle glass device of the present invention is particularly advantageous as it provides a device for customizing the appearance of a vehicle. More specifically, the decorative vehicle glass device can be used to customize a window of a vehicle in a unique and visually appealing manner. This is done via the creation of tendrils of light within the glass body of the device which resembles lighting. In this manner, the decorative vehicle glass device provides a new, unique way of customizing the appearance of a vehicle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a decorative vehicle glass device of the present invention in accordance with the disclosed architecture;

FIG. 2 illustrates a graphical view of a mobile application of one potential embodiment of a decorative vehicle glass device of the present invention in accordance with the disclosed architecture; and

FIG. 3 illustrates a flowchart of a method of using one potential embodiment of a decorative vehicle glass device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a vehicle customization device. There also exists a long-felt need in the art for a vehicle customization device that can be used to customize a window of a vehicle. More specifically, there exists a long-felt need in the art for a decorative vehicle glass device that can be used to customize a window of a vehicle. In addition, there exists a long-felt need in the art for a decorative vehicle glass device that can be used to customize a window of a vehicle in a unique and visually appealing manner.

The present invention, in one exemplary embodiment, is comprised of a decorative vehicle glass device. The device is comprised of a glass body that can be used in vehicle front windshields, rear windshields, engine bay windows, side windows, etc. in different embodiments. The glass body is preferably comprised of a plasma glass or a double-paned glass that allows at least one gas to be positioned within the body between the two panes and/or within the glass. The gas is preferably a hot, ionized gas. More specifically, the gas preferably contains roughly equal quantities of positively charged ions and negatively charged electrons.

The glass body is comprised of at least one electrode. The electrode preferably emits a high-frequency, high-voltage alternating electric current which is transmitted through at least one plasma filament within the glass body. When this occurs, the filaments create colorful tendrils of light within the glass.

In one embodiment, the electrode is in wireless or wired electrical communication with the electrical system of the vehicle. In this embodiment, the voltage created by the electrode increases as the speed of the vehicle increases. As a result, this creates larger and more tendrils as the vehicle accelerates.

Accordingly, the decorative vehicle glass device of the present invention is particularly advantageous as it provides a device for customizing the appearance of a vehicle. More specifically, the decorative vehicle glass device can be used to customize a window of a vehicle in a unique and visually appealing manner. This is done via the creation of tendrils of light within the glass body of the device which resembles lighting. In this manner, the decorative vehicle glass device provides a new, unique way of customizing the appearance of a vehicle.

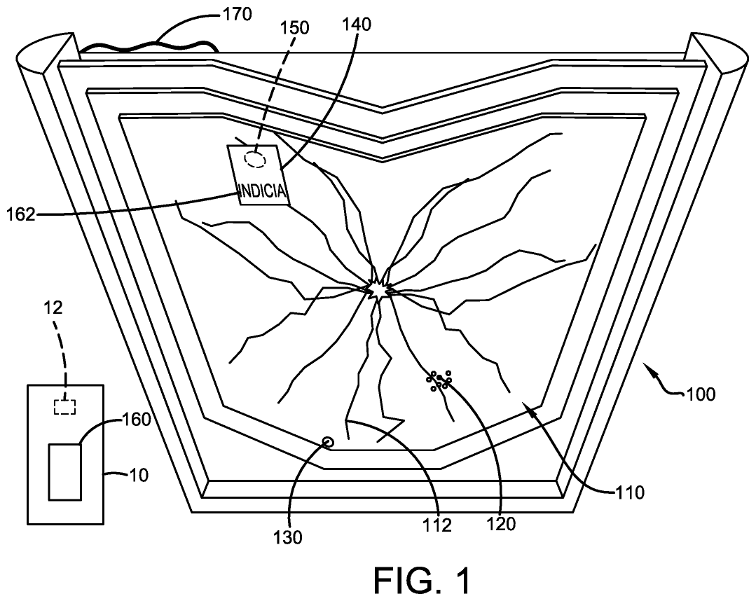

Referring initially to the drawings, FIG. 1 illustrates a front view of one potential embodiment of a decorative vehicle glass device 100 of the present invention in accordance with the disclosed architecture. The device 100 is comprised of a glass body 110 that can be used in vehicle front windshields, rear windshields, engine bay windows, side windows, etc. in different embodiments. The device 100 provides a more aesthetic and customizable look to the vehicle during use.

More specifically, the device 100 is comprised of a glass body 110 that may be any shape that can be used as a vehicle front windshield, rear windshield, engine bay window, side window, etc. in any make and model of a vehicle. The glass body 110 is preferably comprised of a plasma glass or a double-paned glass that allows at least one gas 120 to be positioned within the body 110 between the two panes and/or within the glass 110. Said glass is preferably weatherproof. The gas 120 is preferably a hot, ionized gas containing roughly equal quantities of positively charged ions and negatively charged electrons. Said gas 120 may include but is not limited to neon, argon, xenon, krypton, helium, phosphor, etc. In one embodiment, the gas 120 may be colored.

The glass body 110 is comprised of at least one electrode 130. The electrode 130 preferably emits a high-frequency, high-voltage alternating electric current. In one embodiment, the current may be in the form of a concurrent oscillating voltage. The electric current created by the electrode 130 is transmitted through at least one plasma filament 112 within the glass body 110. When this occurs, the filaments 112 create colorful tendrils of light within the glass 110. More specifically, the gas 120 serves to provide the escaping electrons with an ionizing charge and path for other electrons to follow to create the tendril. During this process, the gas 120 atoms are excited and shed electrons to create the tendril. If colored gas 120 is used, the tendrils of light may also be created in said color.

In one embodiment, the electrode 130 is in wireless or wired electrical communication with the electrical system of the vehicle. In this embodiment, the voltage created by the electrode 130 increases as the speed of the vehicle increases. This creates larger and more tendrils as the vehicle accelerates. In any embodiment, the electrode 130 preferably receives wired electrical power from the vehicle the glass body 110 is installed in/on via at least one wire 170.

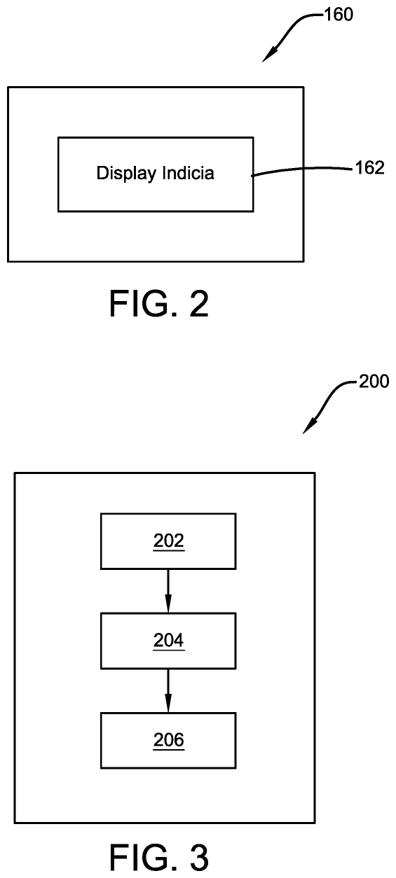

In one embodiment, the glass body 110 is comprised of at least one display screen 140. The display screen 140 may be any type known in the art that can be inserted in or secured onto vehicle glass. In one embodiment, the display 140 is comprised of a cathode-ray tube display, an organic light-emitting diode display, etc. wherein said display 140 allows a user to select and display an indicia 162 such as but not limited to a design, symbol, image, video, a word, a number, etc. on the glass body 110 via a mobile application 160, as shown in FIG. 2.

The display screen 140 is comprised of at least one wireless transmitter 150 that allows the display 140 to wirelessly connect with a receiver 12 of the smart device 100 that runs the mobile application 160 such as but not limited to a cell phone, a tablet, a computer, etc. The transmitter 150 may communicate with the receiver 12 via Wi-Fi, Bluetooth, etc.

The present invention is also comprised of a method of using 200 the device 100, as seen in FIG. 3. First, a device 100 is provided comprised of a glass body 110 comprised of at least one display screen 140 with at least one transmitter 150, and a mobile application 160 [Step 202]. Then, the glass body 110 can be installed into a vehicle as a front windshield, rear windshield, engine bay cover, side window, etc. [Step 204]. Then, the user can use the mobile application 160 to select an indicia 162 to be displayed on the display screen 140, as seen in FIG. 2 [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “decorative vehicle glass device” and “device” are interchangeable and refer to the decorative vehicle glass device 100 of the present invention.

Notwithstanding the forgoing, the decorative vehicle glass device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the decorative vehicle glass device 100 as shown in the FIGS. are for illustrative purposes only, and that many other sizes and shapes of the decorative vehicle glass device 100 are well within the scope of the present disclosure. Although the dimensions of the decorative vehicle glass device 100 are important design parameters for user convenience, the decorative vehicle glass device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decorative vehicle glass device comprising:
a glass body;
a gas;
an electrode; and
a plasma filament.

2. The decorative vehicle glass device of claim 1, wherein the glass body is comprised of a vehicle front windshield, a vehicle rear windshield, a vehicle engine bay cover, or a vehicle side window.

3. The decorative vehicle glass device of claim 1, wherein the electrode is positioned within the glass body.

4. The decorative vehicle glass device of claim 1, wherein the gas is positioned within the glass body.

5. The decorative vehicle glass device of claim 1, wherein the glass body is comprised of a plasma glass.

6. The decorative vehicle glass device of claim 1, wherein the glass body is comprised of a double-paned glass.

7. The decorative vehicle glass device of claim 1, wherein the electrode emits an alternating electric current.

8. The decorative vehicle glass device of claim 1, wherein the electrode emits a concurrent oscillating voltage.

9. The decorative vehicle glass device of claim 1, wherein the gas is comprised of a neon gas, an argon gas, a xenon gas, a krypton gas, a helium gas, or a phosphor gas.

10. The decorative vehicle glass device of claim 1, wherein the gas is comprised of a colored gas.

11. A decorative vehicle glass device comprising:
a glass body;
a display screen comprised of a transmitter; and
a mobile application.

12. The decorative vehicle glass device of claim 11, wherein the glass body is comprised of a vehicle front windshield, a vehicle rear windshield, a vehicle engine bay cover, or a vehicle side window.

13. The decorative vehicle glass device of claim 11, wherein the display screen is comprised of a cathode-ray tube display or an organic light-emitting diode display.

14. The decorative vehicle glass device of claim 11, wherein the display screen displays an indicia.

15. The decorative vehicle glass device of claim 14, wherein the indicia is comprised of a design, a symbol, an image, a video, a word, or a number.

16. The decorative vehicle glass device of claim 11, wherein the transmitter is comprised of a Wi-Fi transmitter or a Bluetooth transmitter.

17. A method of using a decorative vehicle glass device, the method comprising the steps of:
providing a decorative vehicle glass device comprised of a glass body comprised of at least one display screen with at least one transmitter, and a mobile application;
installing the glass body into a vehicle; and
using the mobile application to select an indicia to be displayed on the display screen.

18. The method of claim 17, wherein the indicia is comprised of a design, a symbol, an image, a video, a word, or a number.

19. The method of claim 17, wherein the display screen is positioned on the glass body.

20. The method of claim 17, wherein the display screen is positioned in the glass body.
